(19) United States
(12) Patent Application Publication
(10) Pub. No.: US 2012/0035919 A1
(43) Pub. Date: Feb. 9, 2012

(54) VOICE RECORDING DEVICE AND METHOD THEREOF

(75) Inventors: PING-YANG CHUANG, Tu-Cheng (TW); SHIAN-SHYI SHYU, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/961,424

(22) Filed: Dec. 6, 2010

(30) Foreign Application Priority Data
Aug. 4, 2010 (TW) 99125821

(51) Int. Cl. G10L 19/12

(52) U.S. Cl. 704/221

(57) ABSTRACT

A voice recording method is applied in a recording device that includes a voice receiving unit and a storage unit. The voice receiving unit receives voice signals. The storage unit stores voice models and personal information associated with each voice model. The recording method includes: recording voice signals received by the voice receiving unit and storing the recorded voice signals to the storage unit. Extracting speaker voice features from the recorded speaker's voice. Comparing the extracted features with the voice models to find a match. Obtaining the speaker personal information associated with the voice model when a match is found. Obtaining the storage path of the voice signals stored in the storage unit, then generating an index document according to the obtained voice model and the obtained storage path of the voice signals.

### BACKGROUND

1. Technical Field

The present disclosure relates to audio recording devices and methods thereof and, particularly, to a voice recording device and a voice recording method.

2. Description of Related Art

Usually, speech in a meeting is received through a microphone, and recorded to an electronic audio file without any indexing to accommodate searching for a specific speaker's recording from many speakers of the recorded speech, which can be inconvenient.

### BRIEF DESCRIPTION OF THE DRAWINGS

The components of the drawings are not necessarily drawn to scale, the emphasis instead being placed upon clearly illustrating the principles of a voice recording device and a method thereof. Moreover, in the drawings, like reference numerals designate corresponding parts throughout several views.

FIG. 1 is a block diagram of the voice recording device in accordance with an exemplary embodiment

FIG. 2 is a flowchart of a voice recording method in accordance with an exemplary embodiment.

### DETAILED DESCRIPTION

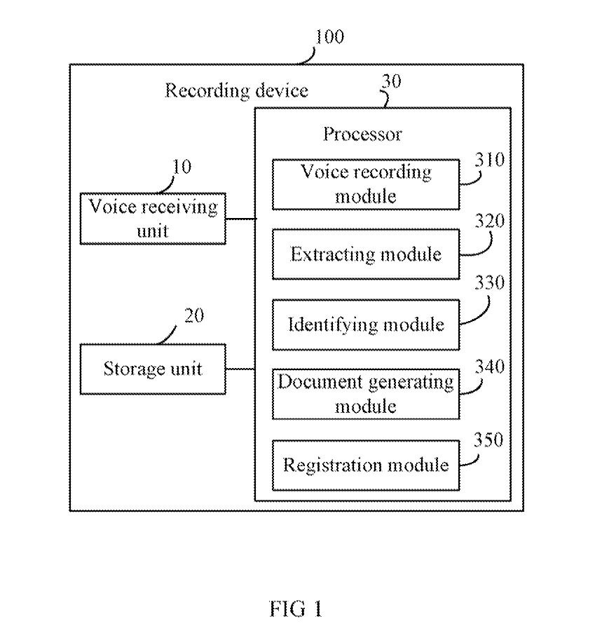

Referring to FIG. 1, an electronic device 100 in accordance with an exemplary embodiment is shown. The electronic device 100 includes a voice receiving unit 10, a storage unit 20, and a processor 30.

The voice receiving unit 10 receives voice signals. In the embodiment, the voice receiving unit 10 is a microphone.

The storage unit 20 stores a number of voice models and personal information associated with each of the voice models. In the embodiment, the personal information associated with one voice model includes a name, an image, and so on.

The processor 30 includes a voice recording module 310, an extracting module 320, an identifying module 330, a document generating module 340, and a registration module 350.

The voice recording module 310 is configured to record voice signals received by the voice receiving unit 10, and store the received voice signals to the storage unit 20.

The extracting module 320 is configured to extract speaker's voice features from the stored voice signals. In the embodiment, the method to extract speaker's features is Mel-Frequency Cepstral Coefficient (MFCC).

The identifying module 330 is configured to compare the extracted features with the voice models to find a match. The document generating module 340 is configured to obtain the personal information from the storage unit 20 associated with the determined voice model, obtain a storage path of the voice signals, and generate an index document according to the personal information and the storage path of the voice signals, and store the index document to the storage unit 20. The document generating module 340 may be further configured to record duration of receiving a speaker's voice signals, and generate an index document according to the personal information, the duration, and the storage path of the voice signals. The duration may include the beginning time and the end time of receiving a speaker's voice signals. For example, an index document may include “Ann, 9:00-9:10, D:\\Voice Signal.”

If there is no match, the registration module 350 is configured to generate a speaker voice model according to the extracted features, associate input personal information with the generated voice model, and store the generated voice model and the associated personal information to the storage unit. The document generating module 340 then generates an index document as described above. In the embodiment, the method used to generate the voice model is Gaussian Mixture Model (GMM).

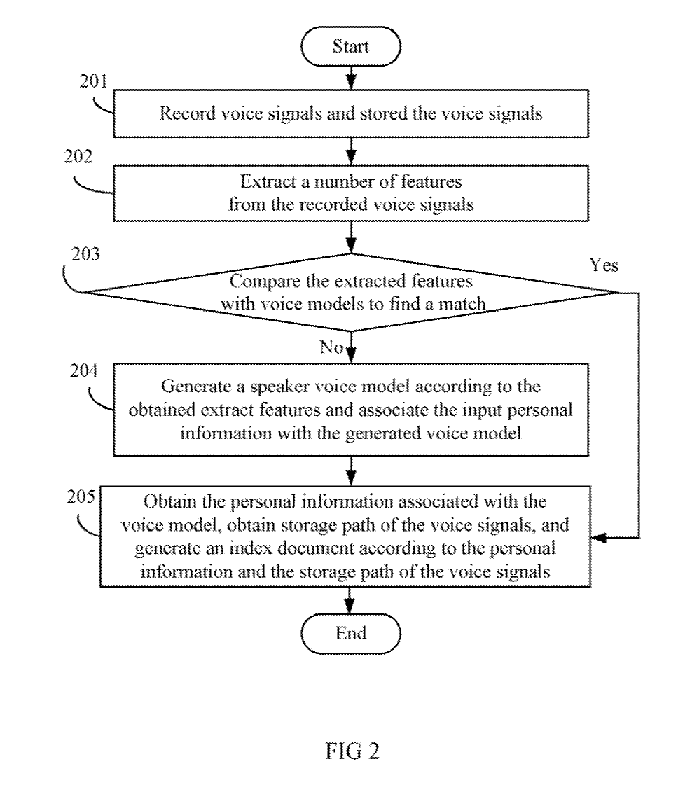

Referring to FIG. 2, a voice recording method in accordance with an exemplary embodiment is shown.

In step S201, the voice recording module 310 records the voice signals received by the voice receiving unit 10, and stores the recorded voice signals to the storage unit 20.

In step S202, the extracting module 320 extracts speaker's voice features from the voice signals.

In step S203, the identifying module 330 compares the extracted features with the voice models to find a match. If no, the procedure goes to S204. Otherwise, the procedure goes to S205.

In step S204, the registration module 350 generates a speaker voice model according to the extracted features, associates the generated voice model with input personal information, and stores the generated voice model and the associated personal information in the storage unit 20.

In step S205, the document generating module 340 obtains the personal information from the storage unit 20 associated with the determined voice model, obtains the storage path of the voice signals, generates an index document according to the obtained personal information and the obtained storage path of the voice signals, and store the index document to the storage unit 20. The document generating module 340 further records the time of receiving a speaker's voice signals, and generates an index document to store to the storage unit 20 according to the obtained personal information, the obtained storage path of the voice signals, and the recorded duration.

In that way, when searching for specific speaker's recorded voice in recording of many speakers, one only need to look at the index document without and cue playback accordingly rather than play and fast forward through a recording, which saves time.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A voice recording device comprising:
a voice receiving unit for receiving voice signals;
a storage unit storing a plurality of voice models and personal information associated with each of voice models; and
a processor comprising:
a voice recording module configured to record the voice signals received by the voice receiving unit and store the recorded voice signals to the storage unit;
an extracting module configured to extract speaker's voice features from the recorded speaker's voice;
an identifying module configured to compare the extracted features with the voice models to find a match; and
a document generating module configured to obtain personal information associated with the voice model matching the extracted features if a match is found, obtain the storage path of the voice signals stored in the storage unit, and generate an index document according to the obtained personal information and the obtained storage path of the voice signals.

2. The voice recording device as described in claim 1, wherein the document generating module is further configured to record duration of receiving a speaker's voice signals and generate the index document according to the obtained personal information, recorded duration, and the obtained storage path of the voice signals.

3. The voice recording device as described in claim 2, wherein the duration comprises a beginning time and an end time of receiving a speaker's voice signals.

4. The voice recording device as described in claim 1, wherein the method to extract features is Mel-Frequency Cepstral Coefficient (MFCC).

5. The voice recording device as described in claim 1, wherein the processor further comprises an registration module configured to generate a speaker voice model according to the extracted features, associate personal information with the generated voice model if the extracted features do not match any of the voice models, the document generating module obtains the personal information associated with the voice model, and the storage path of the voice signals, and generates an index document according to the obtained personal information and obtained storage path of the voice signal.

6. The voice recording device as described in claim 5, wherein the method to generate voice models is Gaussian Mixture Model (GMM).

7. A voice recording method applied in a voice recording device, the voice recording device comprising a voice receiving unit and a storage unit, the voice receiving unit being for receiving voice signals, the storage unit storing a plurality of voice models and personal information associated with each of the voice models, the recording method comprising:
recording voice signals received by the voice receiving unit and storing the recorded voice signals to the storage unit;
extracting voice features from the recorded voice signals;
comparing the extracted features with the voice models to find a match; and
obtaining the speaker personal information associated with the voice model if a match is find, obtaining the storage path of the voice signals stored in the storage unit, and generating an index document according to the obtained personal information and the obtained storage path of the voice signals.

8. The voice recording method as described in claim 7 further comprising: recording the duration of receiving a speaker's voice signals and generating the index document according to the obtained personal information, the recorded duration, and the obtained storage path of the voice signals.

9. The voice recording method as described in claim 8, wherein the duration comprises a beginning time and an end time of receiving a speaker's voice signals.

10. The voice recording method as described in claim 7, wherein the method to extract features is Mel-Frequency Cepstral Coefficient (MFCC).

11. The voice recording method as described in claim 7, wherein the method further comprises:
generating speaker voice model according to the extracted features and associating the input personal information with the generated voice model if the extracted features do not match any of the voice models.

12. The voice recording method as described in claim 11, wherein the method to generate voice models is Gaussian Mixture Model (GMM).
